(19) United States
(12) Patent Application Publication
(10) Pub. No.: US 2025/0321133 A1
(43) Pub. Date: Oct. 16, 2025

(54) MECHANICAL DEVICE FOR WEIGHING AND DISPLAYING THE RESIDUAL GAS IN PORTABLE LIQUID PETROLEUM GAS (LPG) CYLINDERS

(71) Applicant: Wenceslao MOLINE DA LUZ, Montevideo (UY)

(72) Inventor: Wenceslao MOLINE DA LUZ, Montevideo (UY)

(21) Appl. No.: 19/089,104

(22) Filed: Mar. 25, 2025

(30) Foreign Application Priority Data
Apr. 11, 2024 (UY) U-4900

(51) Int. Cl. G01G 21/23

(52) U.S. Cl. CPC G01G 21/23

(57) ABSTRACT

A mechanical device for weighing and displaying the residual gas in portable Liquid petroleum gas (LPG) cylinders including introducing a load centering device “Net Weight”; a weighing platform that includes an upper platform with a metal support for the lower ring of the LPG cylinder, a dial disk with a “Net Weight” load scale, and a spring with a coil spring, in replacement of certain elements of a mechanical analog bath scale.

### FIELD OF THE UTILITY MODEL

The utility model refers to the field of mechanical devices for weighing and displaying the remaining gas in portable LPG cylinders, also known as, for example, gas canisters, bottles, or gas tanks.

The objective of the utility model is to allow the user to obtain visual information about the remaining LPG content in portable cylinders at any time and place, such as at home or in a commercial establishment.

The advantage for the user is that they will be able to have a spare LP gas cylinder available or change the cylinder in use, thus avoiding inconvenient or untimely situations.

### BACKGROUND OF THE UTILITY MODEL

In the various types of portable LPG cylinders, the load is strictly controlled at filling plants using digital scales. This load typically represents 85% of the portable cylinder's capacity.

There are numerous solutions for determining the remaining LPG in a portable cylinder. However, the most accurate method to measure the remaining gas is by weight, since the pressure inside the cylinder remains nearly constant in both liquid and gaseous phases.

Based on my research, electronic scales are not ideal for continuous measurements, which creates a challenge that I believe only a mechanical scale can effectively resolve. However, when using known mechanical scales, the diameter of the portable cylinder obstructs the view of the dial.

Another issue with existing mechanical scales is that portable LPG cylinders have varying tare weights, resulting in different gross weights for each loaded cylinder.

For the reasons outlined above, I can assert that no solution has been universally adopted as a fully satisfactory answer for users.

The utility model presented here is based on the concept of a spring scale (created by Richard Salter in 1838, and mass-produced and marketed since then), which I have modified to achieve the desired objective.

### DESCRIPTION OF THE UTILITY MODEL

The utility model consists of a new configuration introduced into a mechanical analog bathroom scale, offering the advantage of being able to use it to weigh and display the remaining load in portable LPG cylinders, whether made of steel, aluminum, or resin.

The result of this new configuration introduced into a mechanical analog bathroom scale has been named a mechanical device for weighing and displaying the remaining gas in portable LPG cylinders.

The new configuration involves the replacement of: 1—A portion of the weighing mechanism, 2—A zero-alignment mechanism, 3—A dial disk, and 4—An upper platform of a mechanical analog bathroom scale.

The new configuration, referred to as a mechanical device for weighing and displaying the remaining gas in portable LPG cylinders, is composed of:

A “Net Weight” load centering mechanism, replacing the zero-alignment mechanism of a mechanical analog bathroom scale.

A weighing platform consisting of an upper platform with a fixed metal support, introduced in place of the weighing platform of a mechanical analog bathroom scale.

A dial disk with a “Net Weight” load scale printed on it, replacing the dial disk of a mechanical analog bathroom scale.

Once the original zero-alignment mechanism, dial, and spring are removed from the interior of a mechanical analog bathroom scale, they are replaced with a “Net Weight” load centering mechanism, a new dial, and a spring, as described above.

The “Net Weight” load centering mechanism is composed of a load-centering gear wheel with a central screw that axially moves a nut. The nut has a steel wire spring with specific diameters and a defined number of coils. The gear can be externally operated by the user via an opening.

The size of the portable LPG cylinder for which the mechanical device for weighing and displaying the remaining gas is manufactured will determine the diameter of the steel wire and the number of coils.

The weighing platform includes an upper platform with a fixed metal support designed to hold the lower ring of the portable LPG cylinder. This support is adaptable to different diameters of the lower rings of the cylinders and ensures an even load distribution during weighing. The metal support consists of: A three-dimensional triangular structure made of bent and rods welded together, with its three corners welded to individual support brackets. These brackets provide support for the lower rings of portable LPG cylinders.

Two additional rods, each welded at one end to a support bracket for the cylinder's lower ring, with the other ends welded to the rear ends of two semi-parallel flat bars. These flat bars are connected by rivets and fixed to the upper platform. There are three support brackets where the lower ring of the LPG cylinder rests. The four endpoints of the semi-parallel flat bars are positioned on the upper platform, aligning with the four pivots of the internal mechanism of a mechanical analog bathroom scale. The rods forming the three-dimensional triangular structure are inclined to guide the lower ring of the LPG cylinder during placement on the device. The three support brackets for the lower ring of the LPG cylinder are positioned at a specific distance from the upper platform, which depends on the cylinder's size. This ensures that the dial remains visible.

The dial disk with the “Net Weight” scale may feature a single “Net Weight” scale for a specific size of portable LPG cylinder, with a maximum range of 45 kg and a maximum angle of ⅓ of the 360° disk perimeter. Alternatively, it may include specific “Net Weight” scales with lower ranges, occupying slightly smaller angles than ⅓ of the disk perimeter. The load scale may also include a red reference mark at 10% of the load, indicating the reserve range of gas.

The “Net Weight” load centering mechanism connects to the dial disk via the parallel bars, pivot, rack, and pinion of a mechanical analog bathroom scale. The weighing platform is then mounted with springs onto the upper platform, and it is attached to the base of a mechanical analog bathroom scale using cross screws with very light tightening.

For the mechanical device to weigh and display the remaining gas in portable LPG cylinders to operate, the loaded dial disk at maximum capacity must be able to rotate ⅔ of its 360° to account for the full range of tare plus net weight. The dial disk at its maximum load must allow two-thirds of a 360° rotation to cover the entire tare range plus the net weight.

When the mechanical device to weigh and display the remaining gas in portable LPG cylinders is in a resting position, the dial line of the disk will be blank or in the tare zone. This area can be represented with symbols for cylinders based on their respective loads, simplifying subsequent load centering.

Once the user selects the required size of the LPG cylinder, they proceed to calibrate for the “Net Weight” load. At the moment of placing the LPG cylinder on the weighing platform, the user must operate the load-centering gear wheel to align the load scale on the dial.

### BRIEF DESCRIPTION OF THE DRAWINGS

The following is a description of the accompanying drawings, which aid in understanding the Utility Model:

FIG. 1—Top perspective view of the mechanical device for weighing and displaying the remaining gas in portable LPG cylinders, showing the metal support fixedly attached to the upper platform (7), rods of the three-dimensional triangular structure (4), support brackets for the lower ring of the portable LPG cylinders (3), fixed rivets (6), dial with the “Net Weight” load scale (1), flat bars (2), additional rods of the weighing platform (5).

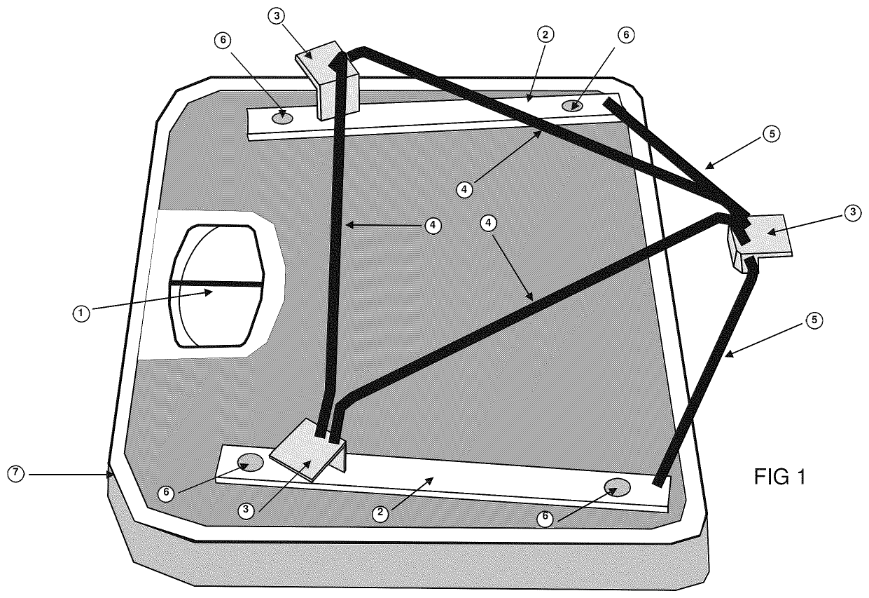

FIG. 2—Lateral perspective view of the metal support for the lower ring of the portable LPG cylinder, showing the metal support and the rods of the three-dimensional triangular structure (4), support brackets for the lower ring of the portable LPG cylinders (3), dial with the “Net Weight” load scale (1), flat bars (2), additional rods of the weighing platform (5).

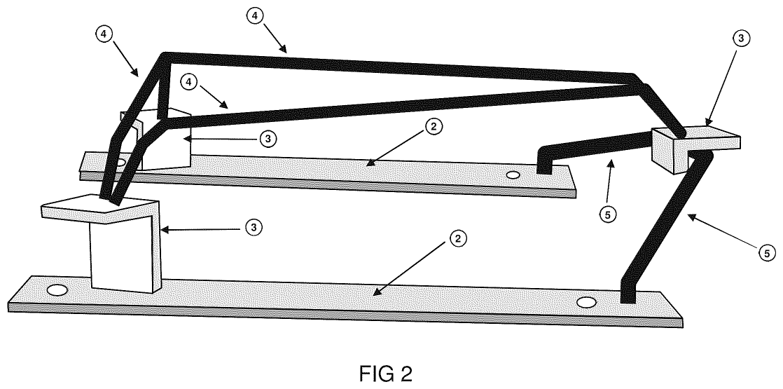

FIG. 3—Top view of the metal support for the lower ring of the portable LPG cylinder, showing the metal support and the rods of the three-dimensional triangular structure (4), support brackets for the lower ring of the portable LPG cylinders (3), dial with the “Net Weight” load scale (1), flat bars (2), additional rods of the weighing platform (5).

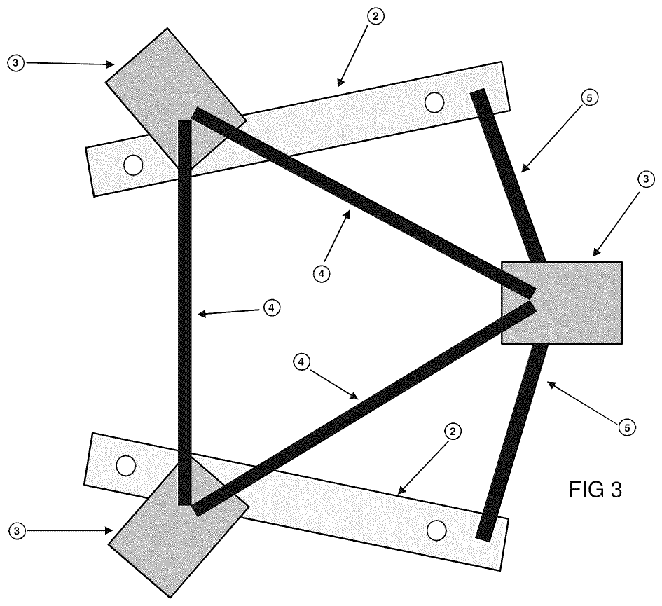

FIG. 4—Front view of the metal support for the lower ring of the portable LPG cylinder, showing the metal support and the rods of the three-dimensional triangular structure (4), support brackets for the lower ring of the portable LPG cylinders (3), dial with the “Net Weight” load scale (1), flat bars (2), additional rods of the weighing platform (5).

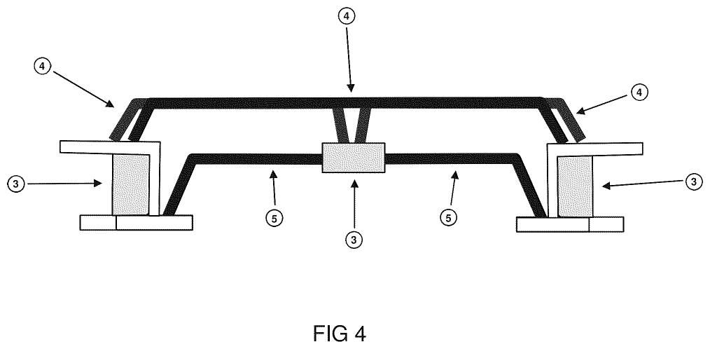

FIG. 5—Rear view of the metal support for the lower ring of the portable LPG cylinder, showing the metal support, and the rods of the three-dimensional triangular structure (4), support brackets for the lower ring of the portable LPG cylinders (3), dial with the “Net Weight” load scale (1), flat bars (2), additional rods of the weighing platform (5).

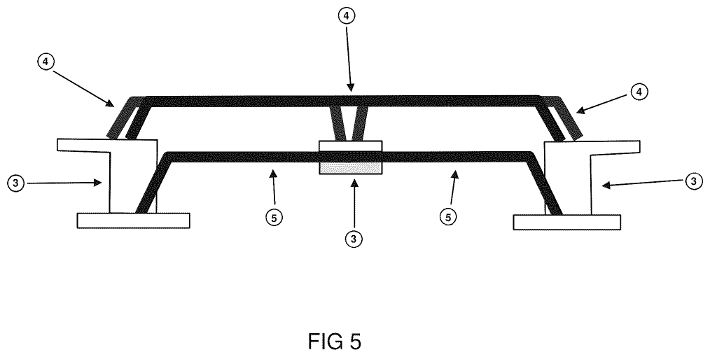

FIG. 6—Bottom view of the metal support for the lower ring of the portable LPG cylinder, showing the metal support, and the rods of the three-dimensional triangular structure (4), support brackets for the lower ring of the portable LPG cylinders (3), dial with the “Net Weight” load scale (1), flat bars (2), additional rods of the weighing platform (5).

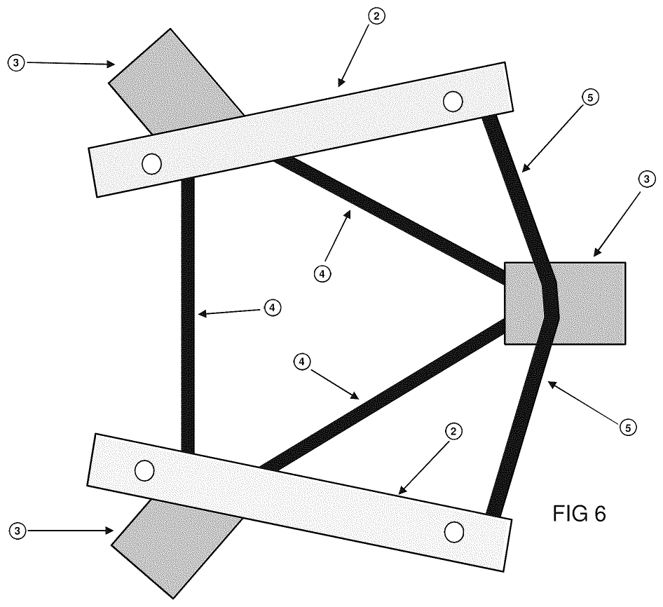

FIGS. 7 and 8—Lateral views of the metal support for the lower ring of the portable LPG cylinder, showing the metal support and the rods of the three-dimensional triangular structure (4), support brackets for the lower ring of the portable LPG cylinders (3), dial with the “Net Weight” load scale (1), flat bars (2), additional rods of the weighing platform (5).

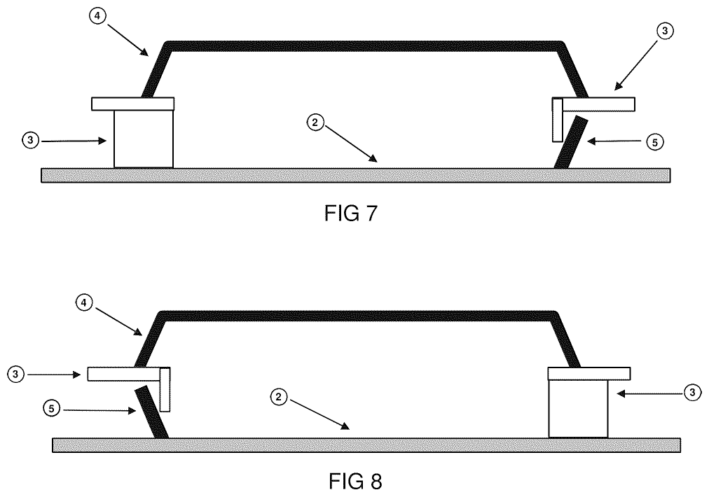

FIG. 9—Lateral view of the mechanical device for weighing and displaying the remaining gas in portable LPG cylinders, showing the metal support fixedly attached to the upper platform (7), rods of the three-dimensional triangular structure (4), support brackets for the lower ring of the portable LPG cylinders (3), dial with the “Net Weight” load scale (1), flat bars (2), additional rods of the weighing platform (5).

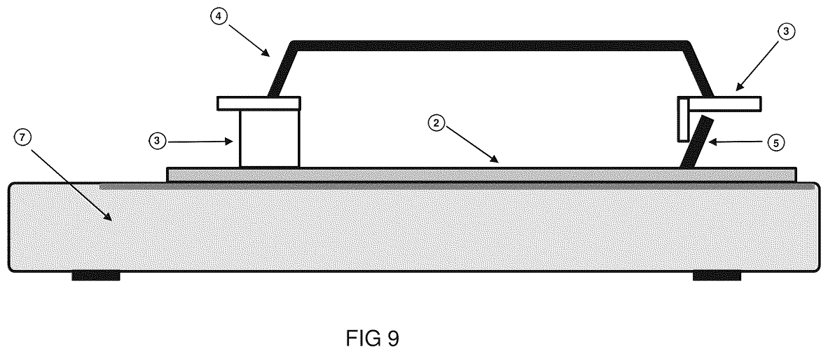

FIG. 10—Front view of the mechanical device for weighing and displaying the remaining gas in portable LPG cylinders, showing the metal support fixedly attached to the upper platform (7), the rods of the three-dimensional triangular structure (4), support brackets for the lower ring of the portable LPG cylinders (3), dial with the “Net Weight” load scale (1), flat bars (2), additional rods of the weighing platform (5).

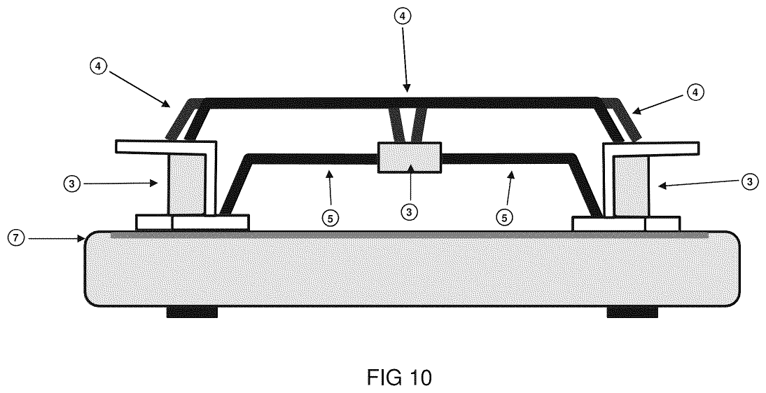

FIG. 11—Top view of the mechanical device for weighing and displaying the remaining gas in portable LPG cylinders, showing the metal support fixedly attached to the upper platform (7), rods of the three-dimensional triangular structure (4), support brackets for the lower ring of the portable LPG cylinders (3), dial with the “Net Weight” load scale (1), flat bars (2), additional rods of the weighing platform (5).

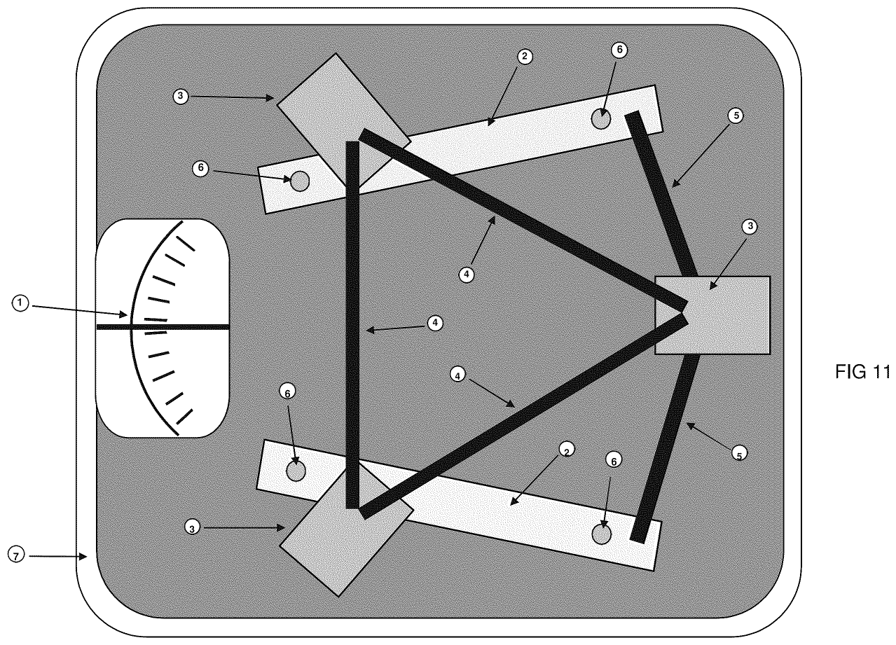

FIG. 12—Rear view of the mechanical device for weighing and displaying the remaining gas in portable LPG cylinders, showing the metal support fixedly attached to the upper platform (7), rods of the three-dimensional triangular structure (4), support brackets for the lower ring of the portable LPG cylinders (3), dial with the “Net Weight” load scale (1), flat bars (2), additional rods of the weighing platform (5), load-centering gear wheel for “Net Weight” (8), the opening that allows its operation.

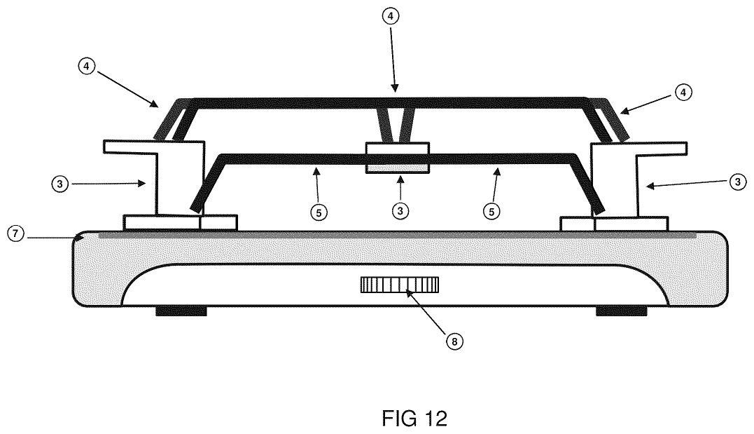

FIG. 13—Exploded view of the parts of the metal support for the lower ring of the portable LPG cylinder, showing the rods of the three-dimensional triangular structure (4), support brackets for the lower ring of the portable LPG cylinders (3), fixed rivets (6), flat bars (2), additional rods of the weighing platform (5).

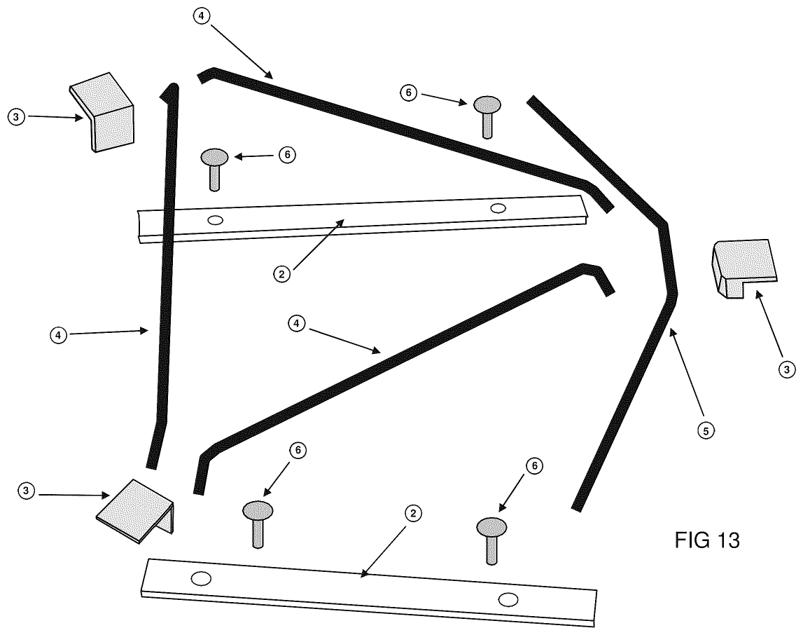

FIG. 14—Expanded exploded view of the parts of the metal support for the lower ring of the portable LPG cylinder, showing the rods of the three-dimensional triangular structure (4), support brackets for the lower ring of the portable LPG cylinders (3), fixed rivets (6), flat bars (2), additional rods of the weighing platform (5).

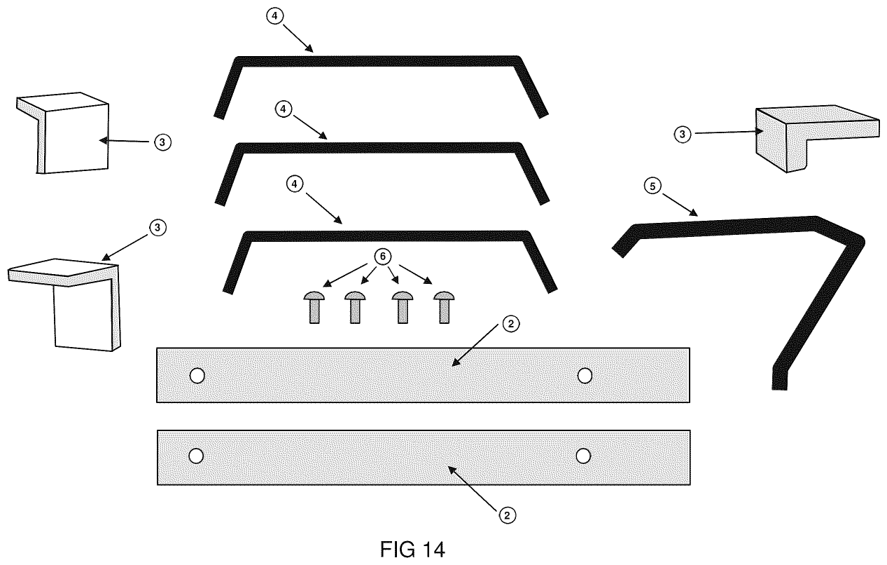

FIG. 15—Dial disk with a “Net Weight” load scale (1) printed on it, considering various sizes of portable LPG cylinders, where a reference image for the zero tare value and the load scale can be seen.

FIG. 16—Top and lateral views of the load-centering gear wheel (8) with a central screw (10) and nut (9) that form part of the “Net Weight” load-centering mechanism.

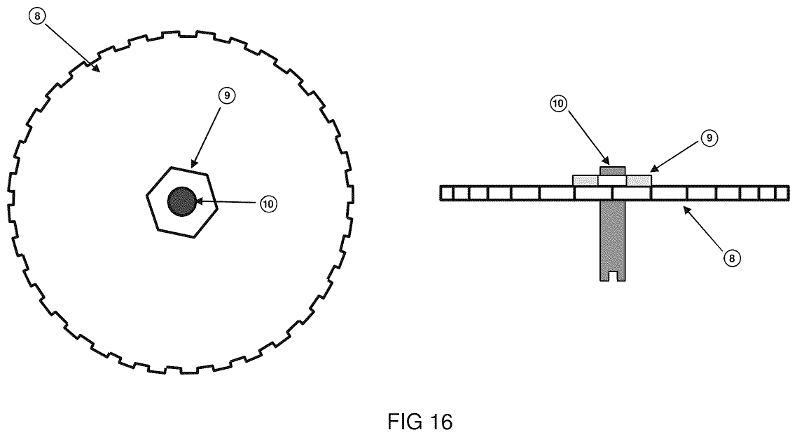

FIG. 17—Springs (11) with coils, which are part of the “Net Weight” load-centering mechanism for different sizes of portable LPG cylinders.

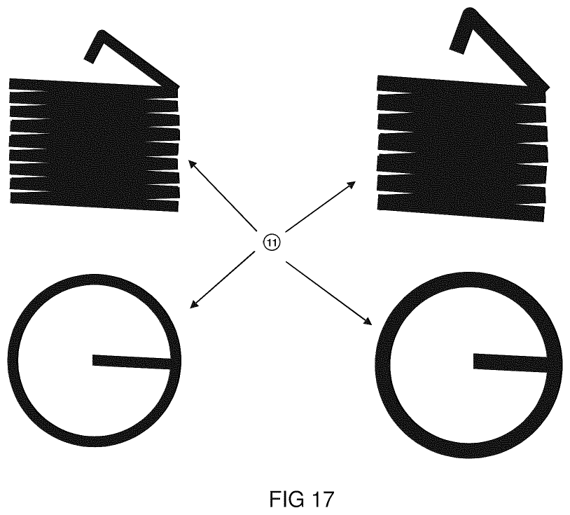

FIG. 18—Internal top view of the mechanical device for weighing and displaying the remaining gas in portable LPG cylinders, showing the upper platform (7), dial disk with a “Net Weight” load scale (1), springs (11) with their coils, central screw (10).

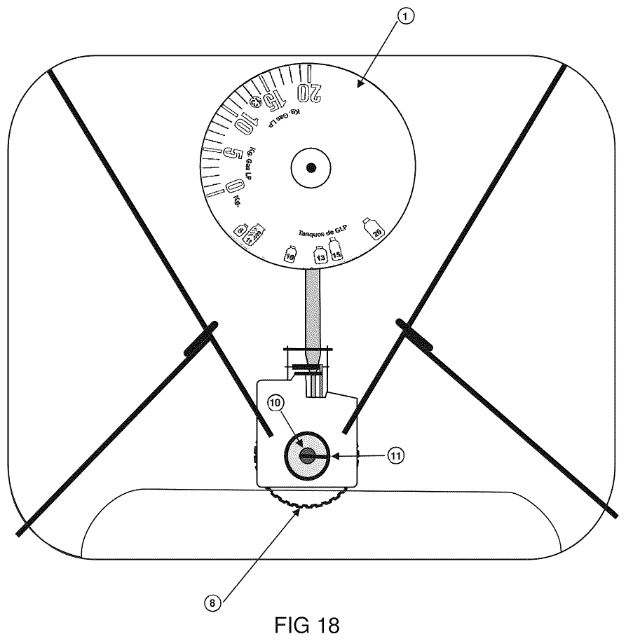

### PREFERRED EMBODIMENT OF THE UTILITY MODEL

A preferred embodiment of the mechanical device for weighing and displaying the remaining gas in portable LPG cylinders, as referenced in the drawings (without limiting the scope of this Utility Model) is described below.

The “Net Weight” load centering mechanism is manufactured with a load-centering gear wheel (8) featuring a central screw (10), a nut (9), and a spring (11). The dimensions of the screw and nut depend on the size of the LPG cylinder for which the device is made. The nut holds a steel-wire spring (11) with a specific number of coils, determined by the size of the portable LPG cylinder for which it is designed. A metal washer is placed at the bottom of the load-centering gear wheel (8).

A three-dimensional triangular structure made of bent metal rods (4) is welded together; its three corners are welded to individual support brackets (3) for the lower rings of portable LPG cylinders. Two of these support brackets are, in turn, welded to two of the ends of two semi-parallel flat bars (2). Two additional bent metal rods that form additional angles (5) are welded at one end to one of the support brackets (3), and at their other end are welded to one of the ends of the two semi-parallel flat bars (2), which are joined by fixed rivets (6) to the upper platform (7). The four endpoints of the two semi-parallel flat bars (2) rest on the outer part of the upper platform (7), with their points of contact coinciding with the four pivots of the internal mechanism of a mechanical analog bathroom scale. The metal support is attached to the upper platform by fixed rivets (6). The rods that form the three-dimensional triangle are angled in such a way as to guide the lower ring of the portable LPG cylinder inward when it is placed onto the device. The three support points for the lower ring of the portable LPG cylinder are set at a distance from the upper platform that depends on the size of the LPG cylinder, ensuring that the dial (1) remains visible.

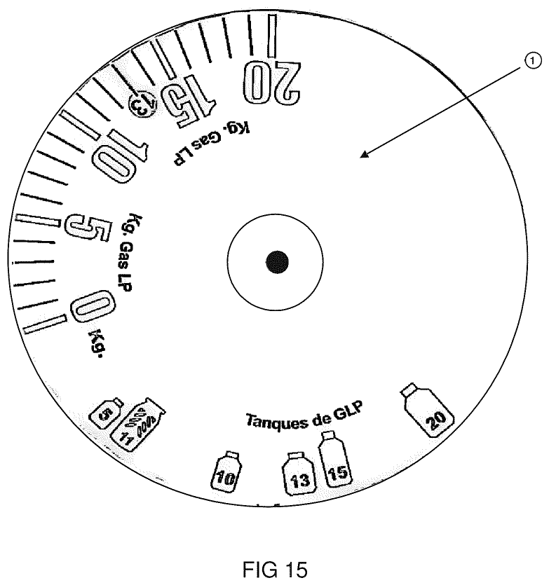

The dial disk with the “Net Weight” load scale (1) is printed with a scale appropriate to the size of the portable LPG cylinders for which the device is made, considering a maximum range of ⅓ of the disk's 360° perimeter. One possible embodiment is shown in FIG. 15, where the dial disk is printed with a load scale covering a maximum range of 20 kg within an angle slightly less than ⅓ of the disk's 360° perimeter.

The “Net Weight” load centering mechanism is connected to the dial disk through the parallel bars, pivot, rack, and pinion of a mechanical analog bathroom scale. The upper platform (7) with the metal support is then mounted onto the device's base using the springs found in the upper platform of a mechanical analog bathroom scale.

### INDUSTRIAL APPLICATION

The metal support fixed to the upper platform can be manufactured using molds followed by a bending process.

The other components and parts of the mechanical device for weighing and displaying the remaining gas in portable LPG cylinders are produced using known methods and materials from the metallurgical industry.

The dial disks of the mechanical device for weighing and displaying the remaining gas in portable LPG cylinders can be printed with various faces.

1. A mechanical device for weighing and displaying remaining gas in portable LPG cylinders comprising:
a net weight load centering mechanism including a load-centering gear wheel, a central screw, a nut, and a steel-wire spring;
a weighing platform including three-dimensional triangular metal support with additional angles, joined to three support brackets, and two semi-parallel flat bars connected by fixed rivets to an upper platform; and
a net weight load scale.
